(19) United States
(12) Patent Application Publication
(10) Pub. No.: US 2026/0075421 A1
(43) Pub. Date: Mar. 12, 2026

(54) ROAMING WIRELESS TRANSMIT/RECEIVE UNIT AUTHORIZATION FOR EDGE APPLICATIONS

(71) Applicant: InterDigital Patent Holdings, Inc., Wilmington, DE (US)

(72) Inventors: Zhibi Wang, Woodridge, IL (US); Michael Starsinic, Newtown, PA (US); Alec Brusilovsky, Downingtown, PA (US)

(73) Assignee: InterDigital Patent Holdings, Inc., Wilmington, DE (US)

(21) Appl. No.: 19/105,258

(22) PCT Filed: Aug. 22, 2023
(86) PCT No.: PCT/US2023/030823

§ 371 Date: Feb. 20, 2025

Related U.S. Application Data
(60) Provisional application No. 63/399,927, filed on Aug. 22, 2022.

(51) Int. Cl. H04W 12/084; H04W 12/02; H04W 12/06; H04W 84/04

(52) U.S. Cl. CPC H04W 12/084; H04W 12/02; H04W 12/06; H04W 84/042

(57) ABSTRACT

Systems, methods, and instrumentalities may be described herein for wireless transmit/receive units (WTRUs) to authorize roaming (e.g., authorize an EEC (Edge Enabler Client) in a roaming WTRLI by a V-ECS (Visiting Edge Configuration Server) token that may be generated by the H-ECS (Home Edge Configuration Server). A first message may be sent. The first message may indicate a request for an authorization token to be used in a visiting network. A second message may be sent. The second message may indicate authentication information. A third message may be sent. The third message may indicate an authorization token. The authorization token may be associated with the authentication information. A fourth message may be received. The fourth message may indicate a validation of the authorization token and may indicate an identity of a visiting network.

### CROSS REFERENCE TO RELATED APPLICATIONS

This application claims the benefit of U.S. Provisional Patent Application No. 63/399,927, filed Aug. 22, 2022, the contents of which are hereby incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities may be described herein for authorizing roaming (e.g., authorizing an Edge Enabler Client (EEC) in a roaming WTRU). A first network node may receive, from a wireless transmit receive unit (WTRU), a first message including temporary public land mobile network (T-PLMN) information, a first authorization token, a first Edge Enabler Client (EEC identifier (ID), and a request to validate the first authorization token. The first network node may determine home public land mobile network (HPLMN) information for the WTRU based on the T-PLMN information. The first network node may determine a second EEC ID based on the first EEC ID. The first network node may determine a second network node based on the HPLMN information and the second EEC ID. The first network node may send, to the second network node, a second message including a request to validate the first authorization token. The first network node may receive, from the second network node, a third message including a validation response. The first network node may generate a second authorization token if the validation response indicates that the first authorization token is valid, and the second authorization token may be associated with a Visited Network Edge Execution Service (V-EES). The first network node may send, to the WTRU, a fourth message including the second authorization token and information about the V-EES information.

The first network node may include a visiting edge computing service (V-ECS), and wherein the second network node further comprises a Home Network Edge Computing Service (H-ECS). The first network node may validate the second authorization token by determining a digital signature of the first authorization token and/or contacting the second network node.

The first EEC ID may be different from the second EEC ID. The first EEC ID may obfuscate an identity of the WTRU. The first network node may determine the second EEC ID based on the first EEC ID by determining the identity of the WTRU based on the first EEC ID. The second EEC ID may be associated with the identity of the WTRU. The first network node may determine the second EEC ID by sending a request to the second network node to decrypt the second EEC ID. The first network node may determine the second EEC ID by performing a decryption and/or a reverse hash.

The first message may include a Generic Public Subscription Identifier (GPSI). The first network node may determine a home network of the WTRU based on the GPSI. The home network of the WTRU may be associated with the second network node.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of an architecture that may be used for one or more edge applications (e.g., a System Aspects 6 (SA6) architecture).

FIG. 3 illustrates an example message flow for an authorization between a client (e.g., an edge enabler client (EEC)) hosted in a roaming WTRU and a server in a visited network (e.g., a visited edge application server (V-ECS)).

### DETAILED DESCRIPTION

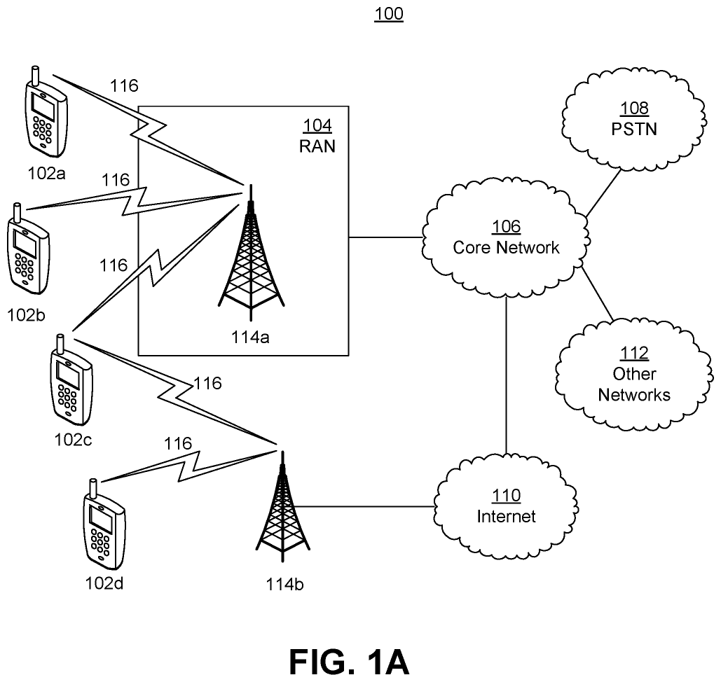

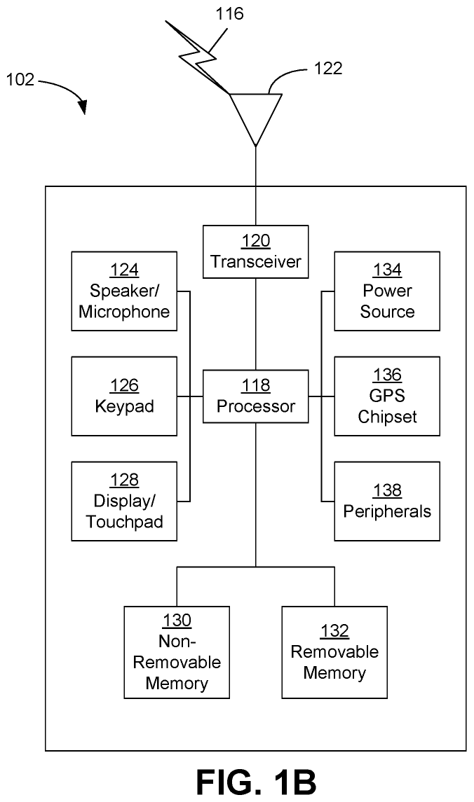

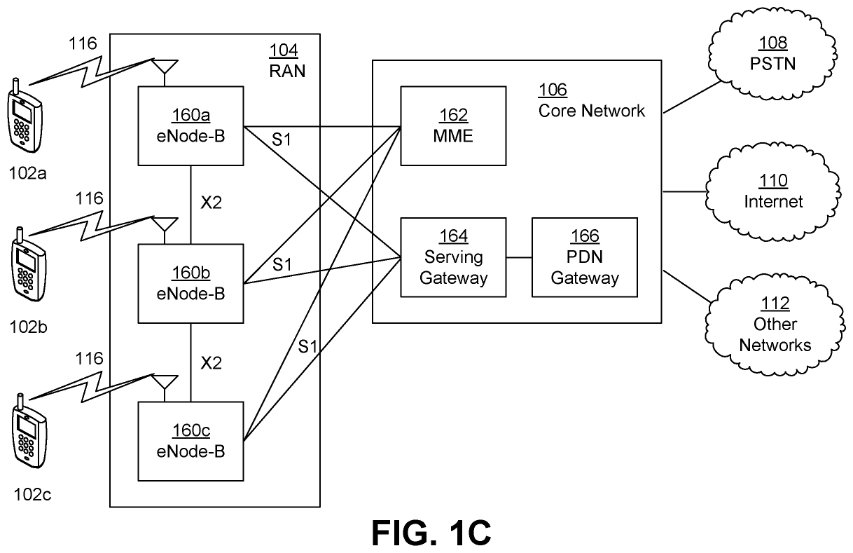

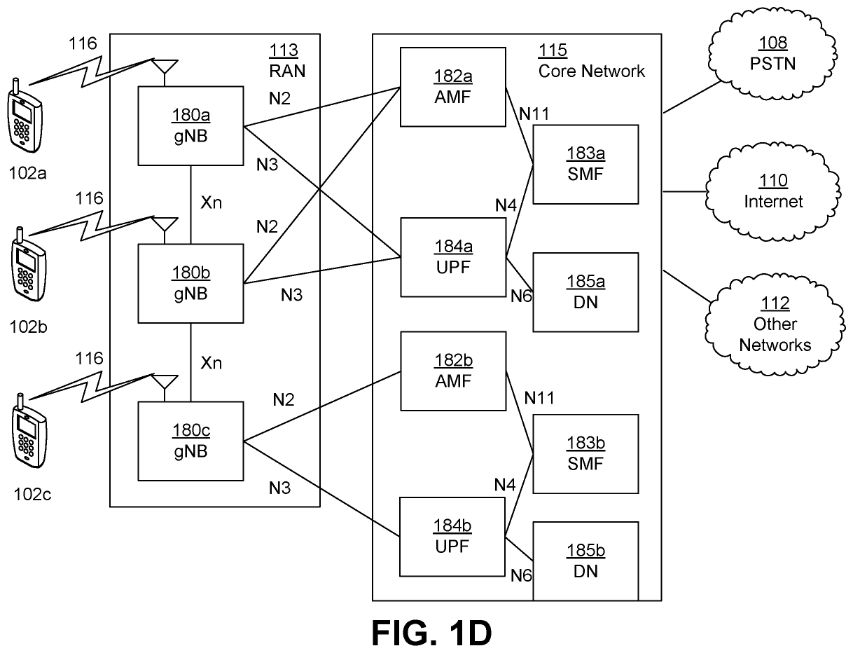

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the uplink (UL) (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following acronyms are used herein:

| | |
|---|---|
| AC | Application Client |
| EAS | Edge Application Server |
| ECS | Edge Configuration Server |
| EDN | Edge Data Network |
| EEC | Edge Enabler Client |
| EEL | Edge Enabler Layer |
| EES | Edge Enabler Server |
| H-ECS | Home ECS (i.e., an ECS in the home network) |
| HPLMN | Home PLMN |
| PLMN | Public Land Mobile Network |
| V-ECS | Visited ECS (i.e., an ECS in the visited network) |
| VPLMN | Visited PLMN |
| UE | User Equipment |

Systems, methods, and instrumentalities may be described herein for wireless transmit/receive units (WTRUs) to authorize roaming (e.g., authorize an EEC (Edge Enabler Client) in a roaming WTRU by a V-ECS (Visiting Edge Configuration Server) token that may be generated by the H-ECS (Home Edge Configuration Server). A first message may be sent. The first message may indicate a request for an authorization token to be used in a visiting network. A second message may be sent. The second message may indicate authentication information. A third message may be sent. The third message may indicate an authorization token. The authorization token may be associated with the authentication information. A fourth message may be received. The fourth message may indicate a validation of the authorization token and may indicate an identity of a visiting network.

Roaming authorization (e.g., a WTRU authorization) may be provided. In examples, an EEC that may be in a roaming WTRU may be authorized by a V-ECS using a token that may be generated by the H-ECS. In examples, a V-ECS may validate a token by checking a digital signature of the token by contacting the H-ECS, a combination thereof, and/or the like. In examples, after authentication, the V-ECS may generate an authorization token to be used by the EEC toward the V-EES. In examples, the token may be privacy-protected to prevent the EEC/WTRU from being tracked by the V-ECS while allowing the authorization.

An application layer for supporting edge services may be provided. In examples, an application architecture for applications (e.g., edge applications) may include a client (e.g., an Edge Enabler Client) that may be deployed in one or more of the WTRU, Edge Configuration Services (ECS), Edge Enabler Services (EES), and/or Edge Application Server (EAS).

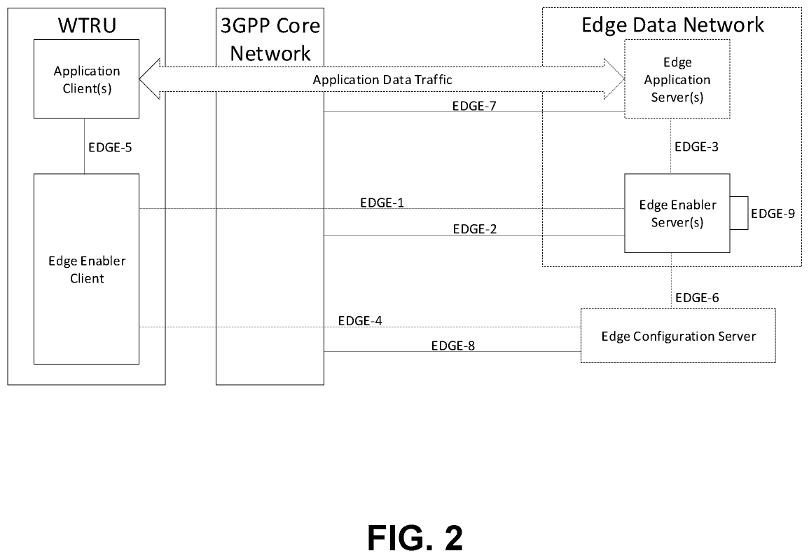

FIG. 2 illustrates an example of an architecture that may be used for one or more edge applications (e.g., a System Aspects 6 (SA6) architecture). The SA6 architecture may include an Application Client (AC), Edge Enabler Client (EEC), Edge Configuration Server (ECS), Edge Enabler Server (EES), and/or Edge Application Server (EAS).

An AC may be provided. In the AC, the WTRU may include an application (e.g., a user application). The AC may include an application that may communicate with the EAS. The AC may include cardinality. In examples, there may be one or more EECs per WTRU. In examples, an AC (e.g., one AC) may use an EEC (e.g., one EEC).

An EEC may be provided. Support (e.g., edge support) may be provided by the EEC to the ACs (e.g., the ACs on the WTRU). The EEC may include a cardinality. In examples, one or more EECs may be included (e.g., included per WTRU). In examples, an AC (e.g., one AC) may use an EEC (e.g., one EEC).

An ECS may be provided. The ECS may provide supporting functions for the EEC and/or EES. For example, the EEC and/or the EES may use the supporting functions to discover EESs. The EESs may provide for one or more EASs. The ECS may include a cardinality. For example, one or more ECSs may be included in the network.

An EES may be provided. The EES may provide supporting functions for an EAS(s) and/or EEC(s). A EES may include a cardinality. In an example, one or more EES(s) may be included per Edge Data Network (EDN), which may be a DNN. In an example, multiple EDNs may be included in the network.

An EAS may be provided. An application server may be resident in the EDN and may be included in the EAS. For example, the EAS may be a software server that may provide a service to the application client. The EAS may include a cardinality. For example, one or more EAS(s) (e.g., multiple EASs) may be included per EDN. An EDN (e.g., each EDN) may include a set of EASs (e.g., a different set of EASs). One or more EASs may serve a group of AC(s)/WTRU(s). In examples, one or more EASs may be exclusive to an AC/WTRU (e.g., a single AC/WTRU).

The terms “roaming network,” “visited network,” and “visiting public land mobile network (VPLMN)” may be used interchangeably herein. The terms “home network” and “home public land mobile network (HPLMN)” may be used interchangeably herein.

To use an edge application (e.g., in an edge infrastructure in a visiting network), a roaming WTRU may request to be authenticated and authorized (e.g., by the H-ECS) before the WTRU is configured and provisioned. For example, a WTRU may be authenticated and authorized before the WTRU contacts a visited edge enabler server (V-EES) and/or a visited edge application server (V-EAS).

In examples, an EEC in a WTRU may be in a home network. Authentication may take place between the EEC and the H-ECS. In examples, a transport layer security (TLS) authentication method may be used. When authentication is successful authentication, the EEC may be authorized by the H-ECS. For examples, the H-ECS may use a local authorization policy to authorize the EEC.

In examples, it may be determined (e.g., determined by the H-ECS after successful authentication and authorization) whether access tokens may be requested for a candidate EES(s) using configuration information. Separate EES access tokens may be issued (e.g., by the H-ECS) to be used for a candidate EES(s) (e.g., a candidate EES(s) using token-based authorization). The EES service tokens may include one or more of an ECS fully qualified domain name (ECS FQDN) (e.g., an issuer), an EEC ID (e.g., a subject), an expected EES service name(s) (e.g., a scope), an EES FQDN (e.g., an audience), and/or an expiration time (e.g., a time when the token may expire and/or a duration of time after which the token may expire). The service provisioning response may be sent (e.g., from the ECS back to the EEC), which may include EES access token(s).

As described herein, mechanisms may be provided to authorize the EEC in a roaming WTRU by the ECS in a visiting network (e.g., a V-ECS). Features described herein may include a means to authorize the EEC in a roaming WTRU by the ECS (e.g., the ECS associated with a visiting network).

In examples, an attempt to use the EDGE application associated with the visiting network may be made by the WTRU (e.g., the WTRU roaming the visiting network). For example, the H-ECS may be contacted by the EEC in the WTRU, to get an authorization token to be used in the visiting network. In examples, the EEC may context the H-ECS when the WTRU may be roaming to the visiting network and may try to use the EDGE application associated with the visiting network.

The V-ECS may be contacted (e.g., by the EEC in the roaming WTRU) with authentication information. An authorization token may be presented (e.g., by the EEC to the V-ECS). For example, the EEC in the roaming WTRU may contact the V-ECS with authentication information and may present the authorization token to the V-ECS.

The token may be validated (e.g., by the V-ECS) by checking a digital signature (e.g., a digital signature of the token). The token may be validated by contacting the H-ECS or an authentication, authorization, and accounting server (AAA Server) in the home network. The token may be validated by invoking an API, which may be provided by the home network.

An authorization token may be generated (e.g., by the V-ECS after authentication and authorization) to be used by the EEC toward the V-EES. The authorization token and V-EES identity may be provided to the EEC (e.g., in the service provisioning response).

The authorization token may be privacy-protected. For example, the authorization token may be privacy-protected to prevent the EEC/WTRU from being tracked by the V-ECS while allowing the authorization.

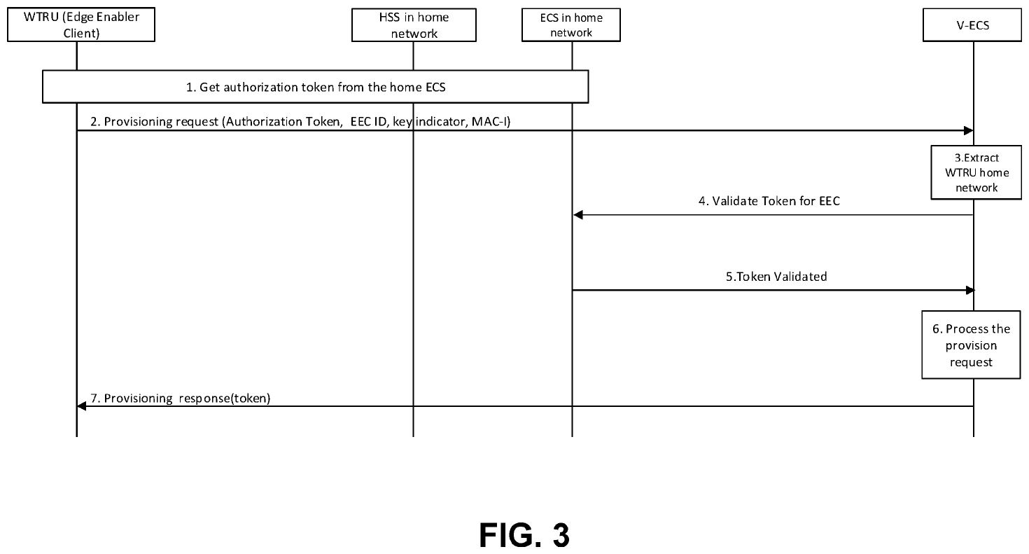

FIG. 3 illustrates an example message flow for authorization between a client (e.g., an edge enabler client (EEC)), hosted in a roaming WTRU and a server in a visited network (e.g., a visited edge application server (V-ECS)).

At 1, the WTRU may be registered in the home network. The WTRU may register to obtain an authorization token to be used with the edge applications in the roaming network. An ECS service authorization token may include one or more of a home ECS FQDN (e.g., an issuer), EEC ID and GPSI (e.g., a subject), expected ECS service name(s) (e.g., a scope), visiting ECS FQDN (e.g., an audience), an expiration time (e.g., a time at which the token may expire, or a duration of time after which the token may expire), or a digital signature (e.g., a digital signature generated by the home ECS). The authorization token may include an endpoint address (e.g., an endpoint address that may be used by the V-ECS to verify the token). The V-ECS (e.g., a first network node) may be provisioned with endpoint addresses that may be valid for an operator (e.g., each operator). The authorization token may include an identifier. The identifier may be an identifier that the V-ECS may use to determine which provisioned endpoint address may be used to verify the EEC's token.

In examples, the process shown at 1 may be performed when the WTRU may be registered in the roaming network. The H-ECS (e.g., a second network node) may be contacted (e.g., contacted by the WTRU) when the WTRU may be registered in the roaming network. The service provisioning request may be sent (e.g., by the WTRU) to the H-ECS. The VPLMN may be indicated (e.g., by the EEC) that the EEC may be registered (e.g., registered in), and the H-ECS may provide a T-HPLMN identifier (e.g., a temporary HPLMN identifier) to the EEC. The T-HPLMN ID may include an identifier that may be pre-arranged between the HPLMN and VPLMN (e.g., to identify the HPLMN temporarily).

In examples, the authorization token may be configured to enable authorization while preventing tracking of the EEC/WTRU by a V-ECS. Tracking may be prevented by utilizing an EEC ID pseudonym instead of the EEC ID while ensuring that the EEC ID pseudonym may not be reused. The EEC ID may be confidentiality-protected (e.g., encrypted and/or hashed with a one-time-use freshness parameter).

At 2, the WTRU may visit the roaming network (e.g., register in the roaming network). A service provisioning request may be sent (e.g., by the EEC in the roaming WTRU) to the ECS in the visiting network. The service provisioning request may include an authorization token (e.g., a first authorization token), EEC ID, an EEC ID pseudonym, a combination thereof, and/or the like. The service provisioning request may include the T-HPLMN ID. The service provisioning request may include a request to validate the authorization token.

At 3, information on the home network of the WTRU may be extracted (e.g., extracted by the V-ECS upon receiving the provisioning request) based on the GPSI in the authorization token. The authorization token may be verified (e.g., by an ECS) if a WTRU is roaming by comparing the home network identifier with the PLMN identifier (e.g., the PLMN identifier that the ECS is associated with). The non-roaming authentication and authorization mechanism among EEC and ECS may be employed (e.g., if the WTRU is not roaming). The T-HPLMN ID may include the service provisioning request. The T-HPLMN ID may be used to determine the HPLMN ID (e.g., the HPLMN information may be determined based on the T-PLMN information. Determination of the HPLMN ID (e.g., using the T-HPLMN ID) may avoid the sending (e.g., via the EEC) of the domain identifier (e.g., the sending of the HPLMN ID to the ECS in an unencrypted manner).

At 4 (e.g., in WTRU roaming scenarios), the token may be validated (e.g., by the V-ECS) by one or more of checking the digital signature (e.g., the digital signature of the token) or sending the token (e.g., to the home ECS). Information from the authorization token may be used (e.g., by the V-ECS) to determine what entity to contact (e.g., an entity in the home network to contact). For example, the token may include an endpoint address (e.g., the endpoint addresses of the H-ECS that the V-ECS may contact).

As shown in FIG. 3, the H-ECS may be contacted (e.g., contacted by the V-ECS) to perform authorization (e.g., to validate the authorization token). An entity (e.g., a different entity (e.g., function)) may be contacted to perform the authorization. In examples, an AAA server or a network exposure function (NEF) may be contacted. As described at 1, endpoint addresses may be provisioned (e.g., provisioned within the ECS) that may be valid for an operator (e.g., each operator).

At 4, the authorization token may include an identifier. The identifier may be an identifier that the V-ECS may use to determine that a provisioned endpoint address may be used to verify the token of the EEC. Examples described herein may provide for EEC/WTRU privacy, and the EEC/WTRU privacy may be protected. For example, a EEC ID may be recovered (e.g., recovered/decrypted by the H-ECS) from a pseudonym, encrypted, and/or hashed value (e.g., recovered before validating the token). In examples, the first EEC ID may include the pseudonym, encrypted, and/or hashed value (e.g., recovered before validating the token). In examples, the second EEC ID may be decrypted based on the first EEC ID. In examples, the second EEC ID may be determined by performing a reverse harsh operation based on the first EEC ID.

The first EEC ID may be distinguishable from the second EED ID. The first EEC ID may obfuscate an identity of the WTRU, and the identity may be determined based on the first EEC ID. The second EEC ID may include (e.g., may be associated with) the identity of the WTRU.

At 5, the H-ECS may send a confirmation message. For example, the H-ECS may send a confirmation message back to the V-ECS if the token validation is successful (e.g., a validation response).

At 6, the configuration request (e.g., the configuration request from the EEC in the roaming WTRU) may be processed (e.g., start to be processed) by the V-ECS. The token validation confirmation may be received (e.g., received by the V-ECS from the H-ECS).

At 7, token(s) (e.g., second authorization token(s)) may be generated. For example, one or more tokens may be generated by the V-ECS to be used with the V-EES(s) for the EEC. The token(s) may be sent to the WTRU (e.g., through secure TLS connection). The EEC and GPSI of the WTRU may be (e.g., successfully) authenticated (e.g., authenticated by the ECS). The EES service tokens may include an ECS FQDN (e.g., an issuer), an EEC ID, a GPSI (e.g., a subject), an expected EES service name(s) (e.g., a scope), a EES FQDN (e.g., an audience), an expiration time (e.g., a time when an expiration may occur, and/or a duration of time after which expiration may occur), a digital signature (e.g., a digital signature generated by the V-ECS), a combination thereof, and/or the like.

Systems, methods, and instrumentalities may be described herein for authorizing roaming (e.g., authorizing an Edge Enabler Client (EEC) in a roaming WTRU). A first network node may receive, from a wireless transmit receive unit (WTRU), a first message including temporary public land mobile network (T-PLMN) information, a first authorization token, a first Edge Enabler Client (EEC identifier (ID), and a request to validate the first authorization token. The first network node may determine home public land mobile network (HPLMN) information for the WTRU based on the T-PLMN information. The first network node may determine a second EEC ID based on the first EEC ID. The first network node may determine a second network node based on the HPLMN information and the second EEC ID. The first network node may send, to the second network node, a second message including a request to validate the first authorization token. The first network node may receive, from the second network node, a third message including a validation response. The first network node may generate a second authorization token if the validation response indicates that the first authorization token is valid, and the second authorization token may be associated with a Visited Network Edge Execution Service (V-EES). The first network node may send, to the WTRU, a fourth message including the second authorization token and information about the V-EES information.

The first network node may include a visiting edge computing service (V-ECS), and wherein the second network node further comprises a Home Network Edge Computing Service (H-ECS). The first network node may validate the second authorization token by determining a digital signature of the first authorization token and/or contacting the second network node.

The first EEC ID may be different from the second EEC ID. The first EEC ID may obfuscate an identity of the WTRU. The first network node may determine the second EEC ID based on the first EEC ID by determining the identity of the WTRU based on the first EEC ID. The second EEC ID may be associated with the identity of the WTRU. The first network node may determine the second EEC ID by sending a request to the second network node to decrypt the second EEC ID. The first network node may determine the second EEC ID by performing a decryption and/or a reverse hash.

The first message may include a Generic Public Subscription Identifier (GPSI). The first network node may determine a home network of the WTRU based on the GPSI. The home network of the WTRU may be associated with the second network node.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-16. (canceled)

17. A first network node, the first network node comprising:
a processor configured to:
receive, from a wireless transmit/receive unit (WTRU), a first message comprising temporary public land mobile network (T-PLMN) information, a first authorization token, a first Edge Enabler Client (EEC) identifier (ID), and a request to validate the first authorization token;
determine home public land mobile network (HPLMN) information for the WTRU based on the T-PLMN information;
determine a second EEC ID based on the first EEC ID;
determine a second network node based on the HPLMN information and the second EEC ID;
send, to the second network node, a second message comprising the request to validate the first authorization token;
receive, from the second network node, a third message comprising a validation response;
generate a second authorization token if the validation response indicates that the first authorization token is valid, wherein the second authorization token is associated with a Visited Network Edge Execution Service (V-EES); and
send, to the WTRU, a fourth message comprising the second authorization token and information about the V-EES.

18. The first network node of claim 17, wherein the first network node further comprises a visiting edge computing service (V-ECS), and wherein the second network node further comprises a Home Network Edge Computing Service (H-ECS).

19. The first network node of claim 17, wherein the processor is further configured to validate the second authorization token by determining a digital signature of the first authorization token.

20. The first network node of claim 17, wherein the first EEC ID is different from the second EEC ID.

21. The first network node of claim 17, wherein the first EEC ID obfuscates an identity of the WTRU, and wherein the second EEC ID is associated with the identity of the WTRU.

22. The first network node of claim 17, wherein the processor being configured to determine the second EEC ID based on the first EEC ID comprises the processor being configured to determine the second EEC ID by sending a request to the second network node to decrypt the second EEC ID.

23. The first network node of claim 17, wherein the processor being configured to determine the second EEC ID based on the first EEC ID comprises the processor configured to determine the second EEC ID by performing at least one of a decryption or a reverse hash.

24. The first network node of claim 17, wherein the first message further comprises a Generic Public Subscription Identifier (GPSI), and wherein the processor is further configured to:
determine a home network of the WTRU based on the GPSI, and wherein the home network is associated with the second network node.

25. A method performed by a first network node, wherein the method comprises:
receiving, from a wireless transmit receive unit (WTRU), a first message comprising temporary public land mobile network (T-PLMN) information, a first authorization token, a first Edge Enabler Client (EEC) identifier (ID), and a request to validate the first authorization token;
determining home public land mobile network (HPLMN) information for the WTRU based on the T-PLMN information;
determining a second EEC ID based on the first EEC ID;
determining a second network node based on the HPLMN information and the second EEC ID;
sending, to the second network node, a second message comprising the request to validate the first authorization token;
receiving, from the second network node, a third message comprising a validation response;
generating a second authorization token if the validation response indicates that the first authorization token is valid, wherein the second authorization token is associated with a Visited Network Edge Execution Service (V-EES); and
sending, to the WTRU, a fourth message comprising the second authorization token and information about the V-EES.

26. The method of claim 25, wherein the first network node further comprises a visiting edge computing service (V-ECS), and wherein the second network node further comprises a Home Network Edge Computing Service (H-ECS).

27. The method of claim 25, wherein the method further comprises validating the second authorization token by determining a digital signature of the first authorization token.

28. The method of claim 25, wherein the first EEC ID is different from the second EEC ID.

29. The method of claim 25, wherein the first EEC ID obfuscates an identity of the WTRU, and wherein the second EEC ID is associated with the identity of the WTRU.

30. The method of claim 25, wherein determining the second EEC ID based on the first EEC ID comprises determining the second EEC ID by sending a request to the second network node to decrypt the second EEC ID.

31. The method of claim 25, wherein determining the second EEC ID based on the first EEC ID comprises determining the second EEC ID by performing at least one of a decryption or a reverse hash.

32. The method of claim 25, wherein the first message further comprises a Generic Public Subscription Identifier (GPSI), and wherein the method further comprises:
determining a home network of the WTRU based on the GPSI, and wherein the home network is associated with the second network node.
